(19) United States
(12) Patent Application Publication
(10) Pub. No.: US 2010/0119880 A1
(43) Pub. Date: May 13, 2010

(54) VARIABLE-FREQUENCY BATTERY REVITALIZING DEVICE

(76) Inventor: Linming Liu, Taipei City (TW)

Correspondence Address: LEONG C LEI, PMB # 1008, 1867 YGNACIO VALLEY ROAD, WALNUT CREEK, CA, 94598, US

(21) Appl. No.: 12/269,895

(22) Filed: Nov. 13, 2008

(51) Int. Cl. H01M 6/50

(52) U.S. Cl. 429/3

(57) ABSTRACT

The variable-frequency battery revitalizing device contains a pulse generation circuit, a frequency generation circuit, a voltage detection circuit, and a frequency control circuit. A lead-acid battery to be revitalized is connected to the pulse generation circuit without being taken off duty and provides electricity to the battery revitalizing device. The voltage detection circuit senses the voltage of the battery being revitalized and produces an appropriate control signal to the frequency control circuit, which in turn determines the frequency of the clock signal produced by the frequency generation circuit. The clock signal drives the pulse generation circuit to produce pulses at the desired frequency and apply the pulses to the battery, thereby completing a feedback loop to automatically adjust the frequency of the pulses applied to the battery.

### TECHNICAL FIELD OF THE INVENTION

The present invention generally relates to devices for revitalizing batteries, and more particularly to such a device for revitalizing lead-acid batteries.

### DESCRIPTION OF THE PRIOR ART

All lead-acid batteries are adversely affected by the buildup of sulfate crystals. As these deposits become thicker and thicker, the battery's ability to accept a charge or deliver energy is drastically diminished, resulting in the perception that the battery is no longer usable.

A conventional method to revitalizing a lead-acid battery is to apply high-frequency pulses to the battery so as to electronically dissolve sulfation formations back into the electrolyte solution. However, it is difficult to tell what is the best frequency and power of the applied pulses. It is quite often that inappropriate pulses are applied and the battery is actually damaged and aging even faster.

### SUMMARY OF THE INVENTION

A variable-frequency battery revitalizing device is provided herein, which contains a pulse generation circuit, a frequency generation circuit, a voltage detection circuit, and a frequency control circuit. A lead-acid battery to be revitalized is connected to the pulse generation circuit without being taken off duty and provides electricity to the battery revitalizing device.

The voltage detection circuit senses the voltage of the battery being revitalized and produces an appropriate control signal to the frequency control circuit, which in turn determines the frequency of a clock signal produced by the frequency generation circuit. The clock signal drives the pulse generation circuit to produce a series of pulses at the desired frequency and apply the pulses to the battery, thereby completing a feedback loop to automatically adjust the frequency of the pulses applied to the battery.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram according to the present invention.

FIG. 2 is a circuit diagram showing a battery revitalizing device according to an embodiment of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

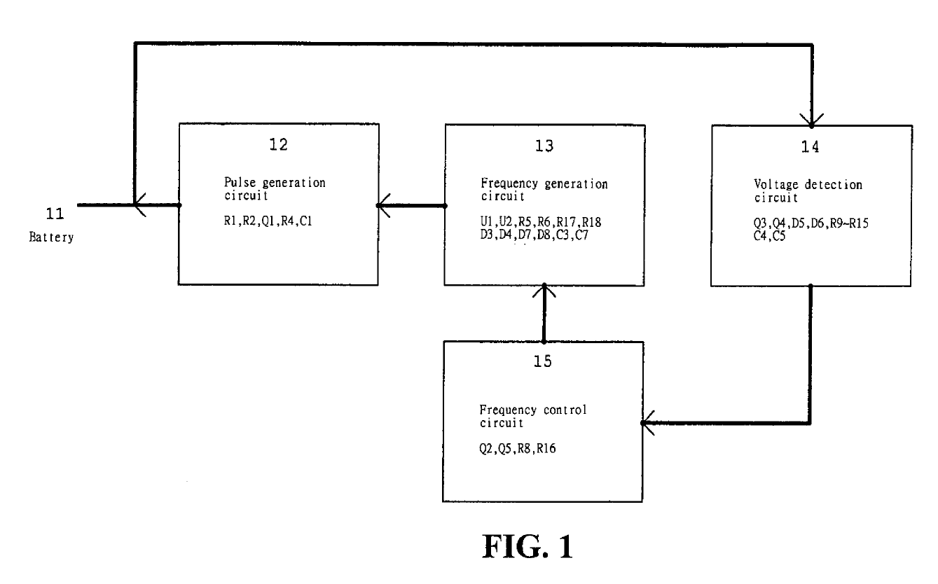

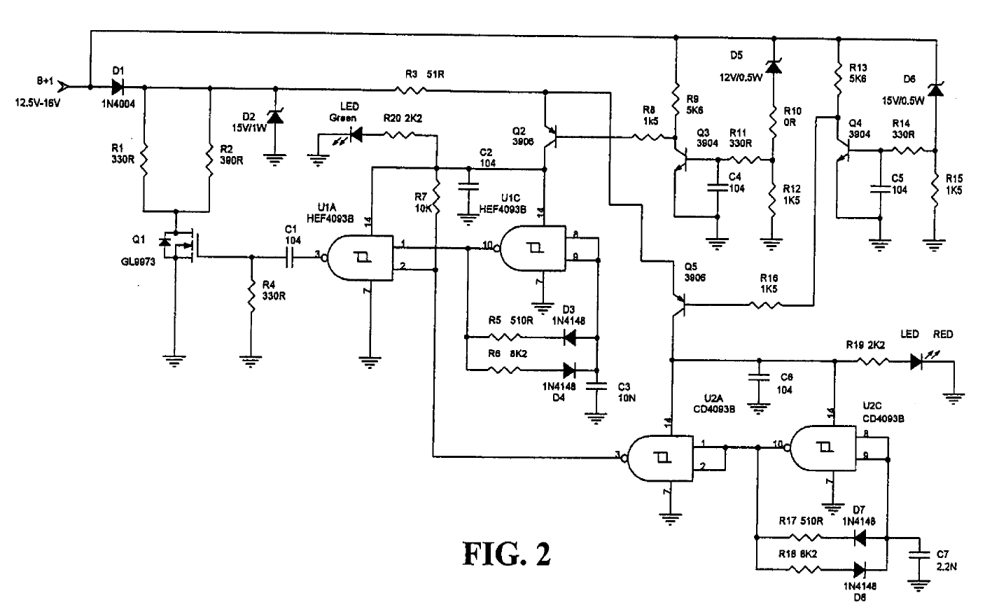

As shown in the functional block diagram of FIG. 1 and the circuit diagram of FIG. 2, a variable-frequency battery revitalizing device according to an embodiment of the present invention contains a pulse generation circuit 12, a frequency generation circuit 13, a voltage detection circuit 14, and a frequency control circuit 15. A battery 11 (such as a 12-V lead-acid battery commonly found on motor devices) is connected to the pulse generation circuit 12 and the voltage detection circuit 14. The battery is not only the one being revitalized by the battery revitalizing device, but also the one providing electricity to the foregoing circuits of the battery revitalizing device.

The pulse generation circuit 12 contains resistors R1, R2, R4, a capacitor C1, and a triode Q1. It generates a series of pulses at a frequency according to a clock signal provided to it by the frequency generation circuit 13. The pulses are then applied to the battery 11 so as to “shake” the sulfate crystals off from the electrode plates of the battery 11. These sulfate crystals then automatically descend to the bottom of the battery 11 by gravity. Please note that the battery 11 does not have to be taken off duty for revitalizing.

The frequency generation circuit 13 contains integrated circuits U1, U2, resistors R5, R6, R7, R18, diodes D3, D4, D7, D8, and capacitors C3, C7. The clock signal to the pulse generation circuit 12 is produced by the integrated circuit U1 by switching to different frequencies in accordance with the output of the integrated circuit U2.

The frequency control circuit 15 contains triodes Q2, Q5, and resistors R8, R16. The frequency control circuit 15 is connected to the frequency generation circuit 13 and controls the integrated circuit U1 of the frequency generation circuit 13 to perform frequency switching in accordance with a control signal of the voltage detection circuit 14.

The voltage detection circuit 14 contains triodes Q3, Q4, diodes D5, D6, resistors R9 to R15, and capacitors C4, C5. The voltage detection 14 is connected to the battery 11 and the frequency control circuit 15.

The operation of the revitalizing circuit is as follows. The voltage detection circuit 14 continuously senses the voltage of the battery 11 being revitalized and produces the appropriate control signal to the frequency control circuit 15, which in turn determines the frequency of the clock signal produced by the frequency generation circuit 13. The clock signal drives the pulse generation circuit 12 to produce pulses at the desired frequency and apply the pulses to the battery 11, thereby completing a feedback loop to automatically adjust the frequency of the pulses applied to the battery 11.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A variable-frequency revitalizing device for a lead-acid battery, comprising:
a voltage detection circuit connected to said lead-acid battery for continuously sensing said lead-acid battery's voltage and producing a first control signal;
a frequency control circuit connected to said voltage detection circuit and producing a second control signal in accordance with said first control signal;
a frequency generation circuit connected to said frequency control circuit and producing a clock signal at a frequency determined by said second control signal; and
a pulse generation circuit connected to said frequency generation circuit and said battery, said pulse generation circuit producing a series of pulses according to said clock signal and applying said series of pulses to said battery;
wherein, said battery also provides electricity to foregoing circuits of said battery revitalizing device.

2. The battery revitalizing device according to claim 1, wherein said voltage detection circuit comprises triodes Q3, Q4, diodes D5, D6, resistors R9 to R15, and capacitors C4, C5.

3. The battery revitalizing device according to claim 1, wherein said frequency control circuit comprises triodes Q2, Q5, and resistors R8, R16.

4. The battery revitalizing device according to claim 1, wherein said frequency generation circuit comprises integrated circuits U1, U2, resistors R5, R6, R7, R18, diodes D3, D4, D7, D8, and capacitors C3, C7.

5. The battery revitalizing device according to claim 1, wherein said pulse generation circuit comprises resistors R1, R2, R4, a capacitor C1, and a triode Q1.
